(19) United States
(12) Patent Application Publication
(10) Pub. No.: US 2015/0171647 A1
(43) Pub. Date: Jun. 18, 2015

(54) METHOD AND APPARATUS FOR HIGH CURRENT CHARGING OF SMART TERMINALS

(71) Applicant: HUIZHOU TCL MOBILE COMMUNICATION CO., LTD., HUIZHOU, GD (CN)

(72) Inventor: Shiqing Zhao, Huizhou (CN)

(73) Assignee: HUIZHOU TCL MOBILE COMMUNICATION CO., LTD., HUIZHOU (CN)

(21) Appl. No.: 14/419,124

(22) PCT Filed: Aug. 16, 2013
(86) PCT No.: PCT/CN2013/081610

§ 371 Date: Feb. 2, 2015

(30) Foreign Application Priority Data
Apr. 24, 2013 (CN) 201310144183.X

(51) Int. Cl. H02J 7/00

(52) U.S. Cl. CPC H02J 7/0031; H02J 7/0052; H02J 7/007; H02J 2007/0039; H02J 2007/0062

(57) ABSTRACT

A method and apparatus for high current charging of a smart terminal includes, when signal wires at positive and negative data cable terminals are in a short circuit status, switching a power supply to a high-current power supply, gradually incrementally increasing a charging current, and synchronously detecting a corresponding charging voltage. The method and apparatus for high current charging also includes determining if the charging current is over-current according to the charging voltage and decreasing the charging current when the charging current is over-current. Thereby, charging of a smart terminal at high current is realized, which shortens the charging time.

### TECHNICAL FIELD

The disclosure relates to the field of smart terminals and, in particular, to a method and apparatus for high current charging of a smart terminal.

### BACKGROUND

Current development trends of intelligent terminals, such as intelligent mobile phones and tablet computers, include display screens having increasingly big sizes, increasingly strong functions and increasingly fast processing speed. All of these changes result in increasingly high power consumption by intelligent terminals. At the same time, batteries used by smart terminals correspondingly have increasingly high capacities. Due to increased battery capacity, battery charging current needs to be increased such that battery charging time remains unchanged. As a result, increasingly high requirements are imposed on charging systems. Charging of intelligent mobile phones or tablet computers with low power consumption according to the prior art is mostly performed through USB (Universal Serial Bus) interfaces. As electrical current, carried by a physical link of a V_{BUS} (power supply terminal) and a GND (ground terminal) of a conventional USB interface, is designed according to industrial standards for USB interfaces, a nominal current carried thereby is 500 mA. However, the link current on V_{BUS} and GND of a conventional USB interface does not meet the requirements of developing intelligent terminals. More and more smart terminals require a charging current far exceeding electrical current provided by a conventional USB interface. Solutions are needed to address the problem of high current charging of intelligent terminals. A solution for high current charging according to the prior art is to add a DC charging cradle. However, DC charging cradles increase cost, and moreover, DC charging cradles are non-standard, which requires a dedicated DC interface charger for each intelligent terminal, leading to additional special accessories for products, increased product cost and relatively poor user experience.

Therefore, the prior art is in need of improvement and development.

### SUMMARY

In light of the above drawbacks of the prior art, a method and apparatus for high current charging of a smart terminal are provided which can control a charging of smart terminals at a high current, and reduce a charging current in case of overcurrent charging. Thereby, charging voltage is maintained within a reasonable range, overcoming the drawbacks and insufficiencies of the prior art.

To solve the technical problem, the present invention employs the following technical solution:

A method for high current charging of a smart terminal includes, when a first signal wire, at a positive data cable terminal, and a second signal wire, at a negative data cable terminal, are in a short circuit status, switching a power supply to a high-current power supply, wherein both the first signal wire, at the positive data cable terminal, and the second signal wire, at the negative data cable terminal, are signal wires for a USB interface of the smart terminal; incrementally increasing a charging current, and synchronously detecting a charging voltage corresponding to the charging current; determining if the charging current is over-current according to the charging voltage; and decreasing the charging current when the charging current is over-current, such that the charging voltage is within a predetermined upper limit range; wherein incrementally increasing the charging current and synchronously detecting the charging voltage corresponding to the charging current comprises: setting the charging current to a preset initial value, detecting the charging voltage when the charging current is at the preset initial value, and recording the charging voltage, corresponding with the present initial charging current value, as the standard charging voltage; and increasing the charging current according to an increase pattern of increasing by a preset increase value, and detecting a charging voltage corresponding to the increased charging current; wherein determining if the charging current is over-current according to the charging voltage comprises: determining if a difference between a charging voltage corresponding to an increased charging current and the standard charging voltage is smaller than a preset voltage threshold value, wherein a charging current is determined to be over-current when a difference is greater than the preset voltage threshold value; when the difference is determined to be less than the preset voltage threshold value, the charging current is increased according to the increase pattern; and when the difference is greater than the preset voltage threshold value, decreasing the charging current according to a decrease sequence of decreasing by a preset decrease value until the difference is less than the preset voltage threshold value; said short circuit status is obtained by detecting at least one of: a current, or a resistance, or transmitted and received data; wherein the preset increase value is 500 mA, the preset decrease value is 100 mA, and the preset voltage threshold value is 0.3 V.

In another embodiment of a method for high current charging of a smart terminal, a power supply terminal and a ground terminal of a USB interface of the smart terminal, as well as a connection cable thereof, correspond to a maximum charging current standard; a USB connector, a power supply terminal of the USB cradle, a ground terminal and a corresponding connection cable of the smart terminal have a cross-sectional area greater than the standard cross-sectional area.

In a further embodiment, a method for high current charging of a smart terminal includes, when a first signal wire, at a positive data cable terminal, and a second signal wire, at a negative data cable terminal, are in a short circuit status, switching a power supply to a high-current power supply, wherein both the first signal wire, at the positive data cable terminal, and the second signal wire, at the negative data cable terminal, are signal wires for a USB interface of the smart terminal; incrementally increasing a charging current, and synchronously detecting a charging voltage corresponding to the charging current; determining if the charging current is over-current according to the charging voltage; and decreasing the charging current when the charging current is determined to be over-current, such that the charging voltage is within a predetermined upper limit range.

In yet another embodiment of a method for high current charging of a smart terminal, a power supply terminal and a ground terminal of a USB interface of the smart terminal, as well as a connection cable thereof, correspond to a maximum charging current standard.

In yet a further embodiment of a method for high current charging of a smart terminal, a USB connector, a power supply terminal of a USB cradle, a ground terminal and a corresponding connection cable of the smart terminal have a cross-sectional area greater than a standard cross-sectional area.

In another embodiment of a method for high current charging of a smart terminal, a short circuit status is obtained by detecting at least one of: a current, a resistance, or transmitted and received data.

In a further embodiment of a method for high current charging of a smart terminal, incrementally increasing a charging current and synchronously detecting a charging voltage corresponding to the charging current comprises: setting the charging current to a preset initial value, detecting the charging voltage when the charging current is at the preset initial value, and recording the charging voltage as a standard charging voltage; and increasing the charging current according to an increase pattern of increasing by a preset increase value, and detecting the charging voltage corresponding to the increased charging current.

In yet another embodiment of a method for high current charging of a smart terminal, determining if a charging current is over-current according to a charging voltage comprises: determining if a difference between the charging voltage corresponding to the increased charging current and a standard charging voltage is smaller than a preset voltage threshold value, wherein the charging current is determined to be over-current when the difference is greater than the preset voltage threshold value.

In yet a further embodiment of a method for high current charging of a smart terminal, when a difference between a charging voltage and a standard charging voltage is less than a preset voltage threshold value, the charging current is increased according to an increase pattern, otherwise charging with an increased charging current as a maximum charging current.

In another embodiment of a method for high current charging of a smart terminal, when a difference between a charging voltage and a standard charging voltage is greater than a preset voltage threshold value, decreasing the charging current according to a decrease sequence of decreasing by a preset decrease value until the difference is smaller than the preset voltage threshold value.

In a further embodiment of a method for high current charging of a smart terminal, a preset increase value is 500 mA, a preset decrease value is 100 mA, and a preset voltage threshold value is 0.3 V.

In yet another embodiment, an apparatus for high current charging of a smart terminal includes a power supply switching module for switching a power supply to a high-current power supply when a first signal wire, at a positive data cable terminal, and a second signal wire, at a negative data cable terminal, are in a short circuit status, wherein both the first signal wire, at the positive data cable terminal, and the second signal wire, at the negative data cable terminal, are signal wires for a USB interface of the smart terminal; a control module for incrementally increasing a charging current, and for synchronously detecting a charging voltage corresponding to the charging current; and a determination module for determining if the charging current is over-current according to the charging voltage; the control module is further for decreasing the charging current when the charging current is determined to be over-current, such that the charging voltage is within a predetermined upper limit range.

In yet a further embodiment of an apparatus for high current charging of a smart terminal, a power supply terminal and a ground terminal of a USB interface of the smart terminal, as well as a connection cable thereof, correspond to a maximum charging current standard.

In another embodiment of an apparatus for high current charging of a smart terminal, a USB connector, a power supply terminal of a USB cradle, a ground terminal and a corresponding connection cable of the smart terminal have a cross-sectional area greater than a standard cross-sectional area.

In a further embodiment of an apparatus for high current charging of a smart terminal, a short circuit status is obtained by detecting at least one of: a current, a resistance, or transmitted and received data by a control module.

In yet another embodiment of an apparatus for high current charging of a smart terminal, a control module is further for setting a charging current to a preset initial value, detecting a charging voltage when the charging current is at the preset initial value, and recording the charging voltage as a standard charging voltage, and increasing the charging current according to an increase pattern of increasing by a preset increase value, and detecting the charging voltage corresponding to the increased charging current.

In yet a further embodiment of an apparatus for high current charging of a smart terminal, a determination module is further for determining if a difference between a charging voltage, corresponding to an increased charging current, and a standard charging voltage is smaller than a preset voltage threshold value, wherein the charging current is determined to be over-current when the difference is greater than the preset voltage threshold value.

In another embodiment of an apparatus for high current charging of a smart terminal, a control module is further for increasing a charging current according to an increase pattern when a difference between a charging voltage and a standard charging voltage is smaller than a preset voltage threshold value, otherwise charging with the increased charging current as a maximum charging current.

In a further embodiment of an apparatus for high current charging of a smart terminal, a control module is further for, when a difference between a charging voltage and a standard charging voltage is greater than a preset voltage threshold value, decreasing a charging current according to a decrease sequence of decreasing by a preset decrease value until the difference is less than a preset voltage threshold value.

In yet another embodiment of an apparatus for high current charging of a smart terminal, a preset increase value is 500 mA, a preset decrease value is 100 mA, and a preset voltage threshold value is 0.3 V.

USB interfaces and corresponding connection cables thereof meet demands of smart terminals for high current charging through USB interfaces in terms of physical characteristics thereof and according to maximum charging current values. A USB interface identifies if a power supply is a high-current power supply if two signal wires, for example, D+ (a positive data cable terminal) signal wire and a D− (a negative data cable terminal) signal wire of a USB interface are in a short circuit status, determines if a charging current is a maximum charging current according to a corresponding charging voltage when increasing the charging current for high current charging, can appropriately reduce the charging current during over-current charging, such that the charging voltage works in a reasonable range, thereby protecting a charger under normal charging current. A method and apparatus for high current charging of a smart terminal can realize intelligent charging such that the smart terminal can be charged at high current, which shortens a charging time and further improves user experience. At the same time, the method and apparatus controls over-current charging and protects charging safety.

### BRIEF DESCRIPTION OF THE ACCOMPANYING DRAWINGS

FIG. 1 depicts a flow chart of a method for high current charging of a smart terminal according to the present invention; and

FIG. 2 illustrates a structure of a USB interface for charging a smart terminal in a method for high current charging of a smart terminal according to the present invention.

### DETAILED DESCRIPTION

To make the objects, technical solutions and advantages, methods and apparatuses for high current charging of a smart terminal are described in detail with reference to the accompanying drawings and exemplary embodiments. It should be understood that the exemplary embodiments are intended for illustrative purposes only, and are not intended to limit the scope of the appending claims in any way.

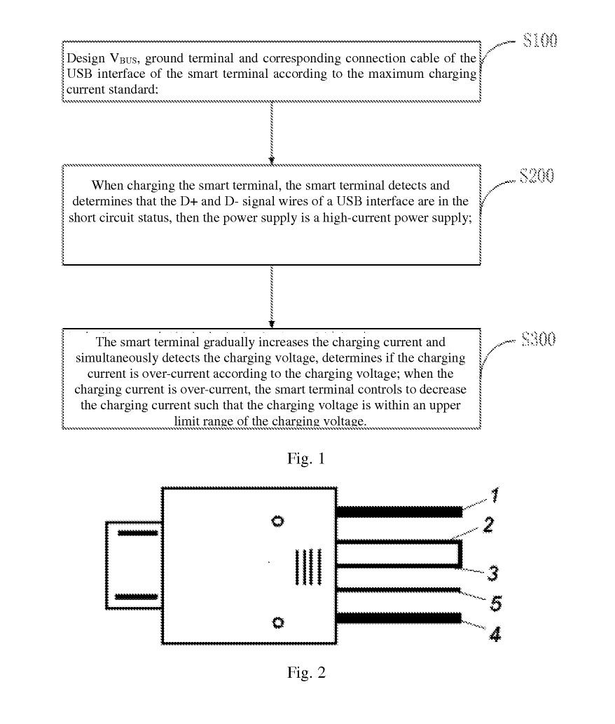

As shown in FIG. 1, a method for high current charging of a smart terminal may include designing a V_{BUS}, a ground terminal and a corresponding connection cable of a USB interface of the smart terminal according to a maximum charging current standard (block S100). Specifically, a USB connector, the power supply terminal of the USB cradle, the ground terminal and the corresponding connection cable of the smart terminal may have a cross-sectional area greater than a standard cross-sectional area. Specifically, a cross-sectional areas of the USB connector, V_{BUS} of the USB cradle, the ground terminal and the corresponding connection cable may be designed, for example, to be 2 times, 3 times or 4 times a size of the standard cross-sectional area. The USB connector and the USB cradle may include various USB charge cable connectors and USB charging cradles for charging intelligent terminals. The corresponding connection cable may include relevant connection cables and PCB wiring that may be connected with the USB interface on the smart terminal, these USB terminals, and corresponding connection cables thereof, may be widened or thickened such that their cross-sectional areas may be, for example, 2 times, 3 times, 4 times, or the like, times a size of a standard cross-sectional area, so as to meet the maximum charging current. The standard cross-sectional area herein refers to cross-sectional areas of USB interfaces, and relevant connection cables thereof, under a standard charging current of 500 mA. Thus, 2 times means 1000 mA, 3 times means 1500 mA, 4 times means 2000 mA, so on and so forth. It should be noted that the design of 2 times, 3 times or 4 times herein may be for design implementation of a maximum charging current of a smart terminal.

When a first signal wire, at a positive data cable terminal, and a second signal wire, at a negative data cable terminal, are in a short circuit status, a power supply may be switched to a high-current power supply (block S200). Both the first signal wire, at the positive data cable terminal, and the second signal wire, at the negative data cable terminal, may be signal wires for a USB interface of a smart terminal. A short circuit status may be obtained by detecting a current, a resistance, or transmitted and received data. Specifically, when charging the smart terminal, the smart terminal may detect and determine that a D+ (a positive data cable terminal) signal wire and a D− (a negative data cable terminal) signal wire of a USB interface are in a short circuit status.

When a power supply for charging a smart terminal is a dedicated high-current charger, the two signal wires, D+ and D−, of the USB interface are connected in short circuit, as shown in FIG. 2. The USB interface shown in FIG. 2 may be capable of high-current charging and may include a power supply terminal 1 (V_{Bus}), a data terminal 2 (D−), a data terminal 3 (D+), a ground terminal 4 (GND) and an ID (identity) terminal 5 (ID). The smart terminal may determine if the charging power supply is a high-current power supply by detecting and determining if the D+ and D− signal wires of the USB interface are connected in a short circuit. Specifically, if the D+ and D− signal wires are connected in a short circuit, as may be determined using a current detection method, a resistance detection method, or a detection method of transmitted and received data, an associated power supply may be determined to be a high-current power supply. When the D+ and D− signal wires of the USB interface are not in the short circuit status, the charging power supply may be determined to be a standard 500 mA charging power supply. Intelligent identification of a charging power supply by the smart terminal may, thereby, be performed, and charging control and intelligent charging may be performed according to the identification results.

Charging current may be incrementally increased, and a charging voltage corresponding to the charging current may be synchronously detected (block S300). Specifically, a smart terminal may incrementally increase the charging current and simultaneously detect the charging voltage. The smart terminal may determine if the charging current is over-current according to the charging voltage and, when the charging current is over-current, the smart terminal may decrease the charging current such that the charging voltage is within an upper limit range of the charging voltage. According to the identification results of block S200, the smart terminal may perform charging control through incrementally increasing the charging current, and simultaneously detecting if the charging voltage is within a safe and reasonable range. When the charging voltage exceeds the safe and reasonable range, i.e. in the case where the charging current is over-current, the smart terminal may further decrease the charging current, thereby, realizing intelligent charging by the smart terminal. In other words, a charging current may be determined to be an over-current according to the charging voltage. The charging current may be decreased when the charging current is determined to be over-current, such that the charging voltage is within a predetermined upper limit range.

Incrementally increasing the charging current and synchronously detecting the charging voltage corresponding to the charging current may include setting the charging current to a preset initial value, detecting the charging voltage when the charging current is at the preset initial value, and recording the charging voltage as the standard charging voltage. The charging current may be increased according to an increase pattern of increasing by a preset increase value, and the charging voltage may be detected corresponding to the increased charging current.

Determining if the charging current is over-current according to the charging voltage may include determining if a difference between a charging voltage, corresponding to an increased charging current, and a standard charging voltage is smaller than a preset voltage threshold value. The charging current may be determined to be over-current when the difference between the charging voltage and the standard charging voltage is greater than the preset voltage threshold value.

When the difference between the charging voltage and the standard charging voltage is less than the preset voltage threshold value, the charging current may be increased according to the increase pattern, otherwise charging may be performed with the increased charging current as a maximum charging current. When the difference between the charging voltage and the standard charging voltage is greater than the preset voltage threshold value, the charging current may be decreased according to a decrease sequence of decreasing by a preset decrease value until the difference between the charging voltage and the standard charging voltage is less than the preset voltage threshold value. The preset increase value may be 500 mA, the preset decrease value may be 100 mA, and the preset voltage threshold value may be 0.3 V.

Specifically, the smart terminal may first set the charging current at 500 mA, may detect the charging voltage when the charging current is 500 mA and may set the charging voltage as the standard charging voltage, and may subsequently set the charging current at an increase sequence of increasing by 100 mA. The smart terminal may detect the charging voltage corresponding to the increased charging current, and may determine if the difference between the charging voltage corresponding to the increased charging current and the standard charging voltage is less than a preset voltage threshold value. If the difference between the charging voltage and the standard charging voltage is less than the preset voltage threshold value, the smart terminal may increase the charging current, otherwise the smart terminal may set the increased charging current as the maximum charging current for charging. The preset voltage threshold value may be 0.3 V. For example, the smart terminal may initialize the charging current of the charging circuit to 500 mA, may detect the charging voltage when the charging current is 500 mA, and may mark the charging voltage at the charging current of 500 mA as V500. Subsequently, the smart terminal may increase the charging current to 600 mA, may mark the charging voltage at the charging current of 600 mA as V600. If the voltage of V600 is lower than the voltage of V500 and the difference thereof is within 0.3 V, i.e. V500-V600<0.3V. The smart terminal may increase the charging current to 700 mA, and may mark the charging voltage at the charging current of 700 mA as V700. If the voltage of V700 is lower than the voltage of V500 and the difference thereof exceeds 0.3 V, i.e. V500−V700>0.3V, the charging current of 700 mA may be the maximum charging current of said charger. If the voltage of V700 is lower than the voltage of V500 and the difference thereof is within 0.3 V, i.e. V500−V700<0.3V, the smart terminal may increase the charging current to 800 mA, and may mark the charging voltage at the charging current of 800 mA as V800. The mobile terminal may compare and determine if the value by which V800 is lower than V500 and is within or exceeding the range of 0.3 V, if within 0.3 V, i.e. V500−V800<0.3V, the smart terminal may increase the charging current until reaching a charging current where the voltage is lower than the voltage at the charging current of 500 mA by a value exceeding 0.3 V, and the charging current at this point is the maximum charging current of said charger.

When the smart terminal detects that the difference between the charging voltage, at a charging current and the standard charging voltage, is greater than the preset voltage threshold value, the smart terminal may set the charging current according to a decrease sequence of decreasing by 100 mA until a difference between the charging voltage at the decreased charging current and the standard charging voltage is less than the preset voltage threshold value, such that the charging voltage of the smart terminal may be controlled within an upper limit range of the charging voltage. For example, if the charging voltage at a charging current is Vx, the smart terminal may mark the charging voltage at the charging current of 500 mA as V500. If V500−Vx>0.3V, then the charging current at this point may be determined to be over-current charging current and the charging current may be decreased such that V500−Vx<0.3V. Consequently, the charging current and the charging voltage may be in a reasonable range, and the charging current may be decreased by 100 mA.

An apparatus for high current charging of a smart terminal is provided, which may be implemented using the above method for high current charging of a smart terminal. Specifically, the apparatus for high current charging of a smart terminal in this embodiment may include a power supply switching module for switching the power supply to a high-current power supply when a first signal wire, at a positive data cable terminal, and a second signal wire, at the negative data cable terminal, are in a short circuit status. Both the first signal wire, at the positive data cable terminal, and the second signal wire, at the negative data cable terminal, may be signal wires for a USB interface of the smart terminal. The apparatus may also include a control module for incrementally increasing a charging current, and for synchronously detecting a charging voltage corresponding to the charging current. The apparatus may further include a determination module for determining if the charging current is over-current according to the charging voltage.

The control module may be further for decreasing the charging current when the charging current is over-current, such that the charging voltage is within a predetermined upper limit range. A power supply terminal and a ground terminal of a USB interface of the smart terminal, as well as, a connection cable thereof, may correspond to a maximum charging current standard. A USB connector, a power supply terminal of a USB cradle, a ground terminal and a corresponding connection cable of the smart terminal may have a cross-sectional area greater than a standard cross-sectional area. A short circuit status may be obtained by detecting a current, a resistance, or transmitted and received data by the control module.

The control module may be further used for setting a charging current to a preset initial value, detecting a charging voltage when the charging current is at the preset initial value, and recording the charging voltage as a standard charging voltage. The control module may increase the charging current according to an increase pattern of increasing by a preset increase value, and may detect a charging voltage corresponding to the increased charging current.

The determination module may be further used for determining if the difference between the charging voltage, corresponding to the increased charging current, and the standard charging voltage is less than a preset voltage threshold value. The charging current may be determined to be over-current when the difference between the charging voltage, corresponding to the increased charging current, and the standard charging voltage is greater than the preset voltage threshold value.

The control module may be further used for increasing the charging current according to the increase pattern when the difference between the charging voltage, corresponding to the increased charging current, and the standard charging voltage is less than the preset voltage threshold value, otherwise charging may be performed with the increased charging current as a maximum charging current.

The control module may be further used for, when the difference between the charging voltage, corresponding to the increased charging current, and the standard charging voltage is greater than the preset voltage threshold value, and may decrease the charging current according to a decrease sequence of decreasing by a preset decrease value until the difference between the charging voltage, corresponding to the increased charging current, and the standard charging voltage is smaller than the preset voltage threshold value. The preset increase value may be 500 mA, the preset decrease value may be 100 mA, and the preset voltage threshold value may be 0.3 V.

It should be understood that the embodiments described above are for illustrative purposes and are not intended to limit the technical solution in any way. To those skilled in the art, addition, deletion, substitution, variations or improvement may be made according to the above description without departing from the spirit and principle of the disclosure. The technical solutions, additions, deletions, substitutions, variations or improvements shall be encompassed by the scope defined by the appended claims.

1. A method for high current charging of a smart terminal, comprising:
when a first signal wire, at a positive data cable terminal, and a second signal wire, at a negative data cable terminal, are in a short circuit status, switching a power supply to a high-current power supply, wherein both the first signal wire, at the positive data cable terminal, and the second signal wire, at the negative data cable terminal, are signal wires for a USB interface of the smart terminal;
incrementally increasing a charging current, and synchronously detecting a charging voltage corresponding to the charging current;
determining if the charging current is over-current according to the charging voltage; and
decreasing the charging current when the charging current is over-current, such that the charging voltage is within a predetermined upper limit range;
wherein incrementally increasing the charging current and synchronously detecting the charging voltage corresponding to the charging current comprises:
setting the charging current to a preset initial value, detecting the charging voltage when the charging current is at the preset initial value, and recording the charging voltage, corresponding with the present initial charging current value, as the standard charging voltage; and
increasing the charging current according to an increase pattern of increasing by a preset increase value, and detecting a charging voltage corresponding to the increased charging current;
wherein determining if the charging current is over-current according to the charging voltage comprises:
determining if a difference between a charging voltage corresponding to an increased charging current and the standard charging voltage is smaller than a preset voltage threshold value, wherein a charging current is determined to be over-current when a difference is greater than the preset voltage threshold value;
when the difference is determined to be less than the preset voltage threshold value, the charging current is increased according to the increase pattern; and
when the difference is greater than the preset voltage threshold value, decreasing the charging current according to a decrease sequence of decreasing by a preset decrease value until the difference is less than the preset voltage threshold value; said short circuit status is obtained by detecting at least one of: a current, a resistance, or transmitted and received data;
wherein the preset increase value is 500 mA, the preset decrease value is 100 mA, and the preset voltage threshold value is 0.3 V.

2. The method for high current charging of a smart terminal as set forth in claim 1, wherein a power supply terminal and a ground terminal of the USB interface of the smart terminal, as well as a connection cable thereof, correspond to the maximum charging current standard;
wherein the USB connector, the power supply terminal of the USB cradle, the ground terminal and a corresponding connection cable of the smart terminal have a cross-sectional area greater than a standard cross-sectional area.

3. A method for high current charging of a smart terminal, comprising:
when a first signal wire, at a positive data cable terminal, and a second signal wire, at a negative data cable terminal, are in a short circuit status, switching a power supply to a high-current power supply, wherein both the first signal wire, at the positive data cable terminal, and the second signal wire, at the negative data cable terminal, are signal wires for a USB interface of the smart terminal;
incrementally increasing a charging current, and synchronously detecting a charging voltage corresponding to the charging current;
determining if the charging current is over-current according to the charging voltage; and
decreasing the charging current when the charging current is over-current, such that the charging voltage is within a predetermined upper limit range.

4. The method for high current charging of a smart terminal as set forth in claim 3, wherein a power supply terminal and a ground terminal of the USB interface of the smart terminal, as well as a connection cable thereof, correspond to a maximum charging current standard.

5. The method for high current charging of a smart terminal as set forth in claim 4, wherein the USB connector, the power supply terminal of the USB cradle, the ground terminal and a corresponding connection cable of the smart terminal have a cross-sectional area greater than a standard cross-sectional area.

6. The method for high current charging of a smart terminal as set forth in claim 3, wherein said short circuit status is obtained by detecting at least one of: a current, by detecting a resistance, or by detecting transmitted and received data.

7. The method for high current charging of a smart terminal as set forth in claim 3, wherein incrementally increasing the charging current and synchronously detecting the charging voltage corresponding to the charging current comprises:
setting the charging current to a preset initial value, detecting a charging voltage when the charging current is at the preset initial value, and recording the charging voltage as a standard charging voltage; and
increasing the charging current according to an increase pattern of increasing by a preset increase value, and detecting a charging voltage corresponding to the increased charging current.

8. The method for high current charging of a smart terminal as set forth in claim 7, wherein determining if the charging current is over-current according to the charging voltage comprises:
determining if a difference between the charging voltage corresponding to the increased charging current and the standard charging voltage is smaller than a preset voltage threshold value;
wherein the charging current is determined to be over-current when the difference is greater than the preset voltage threshold value.

9. The method for high current charging of a smart terminal as set forth in claim 8, wherein the method further comprises:
when the difference is less than the preset voltage threshold value, increasing the charging current according to the increase pattern, otherwise charging with the increased charging current as the maximum charging current.

10. The method for high current charging of a smart terminal as set forth in claim 8, wherein the method further comprises:
when the difference is greater than the preset voltage threshold value, decreasing the charging current according to a decrease sequence of decreasing by a preset decrease value until the difference is smaller than the preset voltage threshold value.

11. The method for high current charging of a smart terminal as set forth in claim 10, wherein the preset increase value is 500 mA, the preset decrease value is 100 mA, and the preset voltage threshold value is 0.3 V.

12. An apparatus for high current charging of a smart terminal, comprising:
a power supply switching module for switching a power supply to a high-current power supply when a first signal wire, at a positive data cable terminal, and a second signal wire, at a negative data cable terminal, are in a short circuit status, wherein both the first signal wire, at the positive data cable terminal, and the second signal wire, at the negative data cable terminal, are signal wires for a USB interface of the smart terminal;
a control module for incrementally increasing a charging current, and for synchronously detecting a charging voltage corresponding to the charging current; and
a determination module for determining if the charging current is over-current according to the charging voltage;
the control module is further for decreasing the charging current when the charging current is over-current, such that the charging voltage is within a predetermined upper limit range.

13. The apparatus for high current charging of a smart terminal as set forth in claim 12, wherein a power supply terminal and a ground terminal of the USB interface of the smart terminal, as well as a connection cable thereof, correspond to a maximum charging current standard.

14. The apparatus for high current charging of a smart terminal as set forth in claim 13, wherein the USB connector, the power supply terminal of the USB cradle, the ground terminal and a corresponding connection cable of the smart terminal have a cross-sectional area greater than a standard cross-sectional area.

15. The apparatus for high current charging of a smart terminal as set forth in claim 12, wherein said short circuit status is obtained by detecting at least one of: a current, a resistance, or transmitted and received data by the control module.

16. The apparatus for high current charging of a smart terminal as set forth in claim 12, wherein the control module is further for setting the charging current to a preset initial value, detecting a charging voltage when the charging current is at the preset initial value, and recording the charging voltage as a standard charging voltage, and increasing the charging current, according to an increase pattern of increasing, by a preset increase value each time, and detecting the charging voltage corresponding to the increased charging current.

17. The apparatus for high current charging of a smart terminal as set forth in claim 16, wherein the determination module is further for determining if a difference between the charging voltage corresponding to the increased charging current and the standard charging voltage is smaller than a preset voltage threshold value;
wherein the charging current is determined to be over-current when the difference is greater than the preset voltage threshold value.

18. The apparatus for high current charging of a smart terminal as set forth in claim 17, wherein the control module is further for increasing the charging current according to the increase pattern when the difference is less than the preset voltage threshold value, otherwise charging with the increased charging current as a maximum charging current.

19. The apparatus for high current charging of a smart terminal as set forth in claim 17, wherein the control module is further for, when the difference is greater than the preset voltage threshold value, decreasing the charging current according to a decrease sequence of decreasing by a preset decrease value until the difference is less than the preset voltage threshold value.

20. The apparatus for high current charging of a smart terminal as set forth in claim 19, wherein the preset increase value is 500 mA, the preset decrease value is 100 mA, and the preset voltage threshold value is 0.3 V.
